(19) United States
(12) Patent Application Publication
(10) Pub. No.: US 2026/0121358 A1
(43) Pub. Date: Apr. 30, 2026

(54) ELECTRICAL CONNECTOR WITH AN IMPROVED GROUND PLANE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: SHUO-HSIU HSU, Phoenix, AZ (US)

(21) Appl. No.: 18/928,546

(22) Filed: Oct. 28, 2024

(51) Int. Cl. H01R 13/6596; H01R 12/71; H01R 13/24; H01R 13/405; H01R 13/50; H01R 13/66

(52) U.S. Cl. CPC H01R 13/6596; H01R 12/714; H01R 13/2435; H01R 13/405; H01R 13/50; H01R 13/6658

(57) ABSTRACT

An electrical connector includes: an insulating housing having an upper face and a lower face; a ground plane insert-molded in the insulating housing and substantially parallel to the upper and lower face; plural signal terminals; plural upper ground terminals; and plural lower ground terminals; wherein the insulating housing has plural upper passages opening upwards through the upper face and plural lower passages opening downwards through the lower face, the upper terminals are inserted in the upper passages from the upper face and connected with the ground plane, and the lower ground terminals are inserted in the lower passages from the lower face and connected with the ground plane.

### BACKGROUND OF THE INVENTION

### 1. Field of the Invention

The present invention relates to an electrical connector with a ground plane.

### 2. Description of Related Arts

U.S. Pat. No. 8,764,464 discloses an electrical connector with a shieldless ground coupling assembly to shift the electrical resonance of the ground contacts to higher frequencies, thereby improving both insertion loss and crosstalk. CPU sockets or interposer connector with multiple contacts are also added with metal members, such as CN111431000A. U.S. Pat. No. 10,490,951 discloses a shielding member provided on an insulating body with plural holes for plural signal and grounding terminals to pass through, wherein the grounding terminals are in contact with the shielding member. The shielding member may be made of a metal plate embedded in the insulating body or may also be a metal plating layer plated on the insulating body. CN111431000A discloses an electrical connector with multiple upright shielding plates to reduce cross-talk. It is difficult for such electrical connector with hundreds or thousands of terminals and a small size to add ground members or shielding members. How to add ground members is significant to mass production.

Therefore, an improved electrical connector is desired to overcome the disadvantages of the related art.

### SUMMARY OF THE INVENTION

An object of the present invention is to provide an electrical connector with an improved ground plane.

In order to achieve above-mentioned object, an electrical connector comprises: an insulating housing having an upper face and a lower face; a ground plane insert-molded in the insulating housing and substantially parallel to the upper and lower faces; a plurality of signal terminals; a plurality of upper ground terminals; and a plurality of lower ground terminals; wherein the insulating housing has a plurality of upper passages opening upwards through the upper face and a plurality of lower passages opening downwards through the lower face, the upper terminals are inserted in the upper passages from the upper face and connected with the ground plane, and the lower ground terminals are inserted in the lower passages from the lower face and connected with the ground plane.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a perspective view of an electrical connector of a first embodiment of this present invention;

FIG. 2 is a cross-sectional view of the electrical connector taken along line A-A in FIG. 1;

FIG. 3 is an exploded perspective view of the electrical connector in FIG. 1;

FIG. 4 is a top plane view of the terminals and the metal plate in FIG. 3;

FIG. 5 is a partially exploded perspective view of the terminals and the metal plate in FIG. 4;

FIG. 6 is a perspective view of an electrical connector of a second embodiment of this present invention;

FIG. 7 is a partially exploded perspective view of the terminals and the PCB in FIG. 6;

FIG. 8 is a perspective view of an electrical connector of a third embodiment of this present invention;

FIG. 9 is a perspective view of the terminals and the PCB in FIG. 9;

FIG. 10 is another perspective view of the terminals and the PCB in FIG. 9;

FIG. 11 is a cross-sectional view of the terminals and the PCB taken along line B-B in FIG. 9;

FIG. 12 is a perspective view of an electrical connector of a fourth embodiment of this present invention;

FIG. 13 is a cross-sectional view of the terminals and the PCB taken along line C-C in FIG. 13;

FIG. 14 is a partially exploded perspective view of the terminals and the metal plate of a fifth embodiment of this present invention;

FIG. 15 is a partially exploded perspective view of the terminals and the metal plate of a sixth embodiment of this present invention;

FIG. 16 is a perspective view of an electrical connector of a seventh embodiment of this present invention, wherein three states of the electrical connector are shown;

FIG. 17 is a perspective view of a terminal in three states in FIG. 16; and

FIG. 18 is a cross sectional view of the electrical connector in three states.

### DETAILED DESCRIPTION OF THE PREFERRED EMBODIMENTS

Reference will now be made in detail to the preferred embodiments of the present invention.

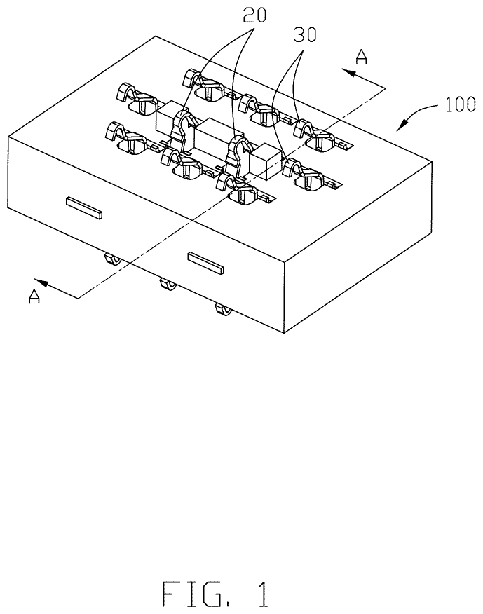

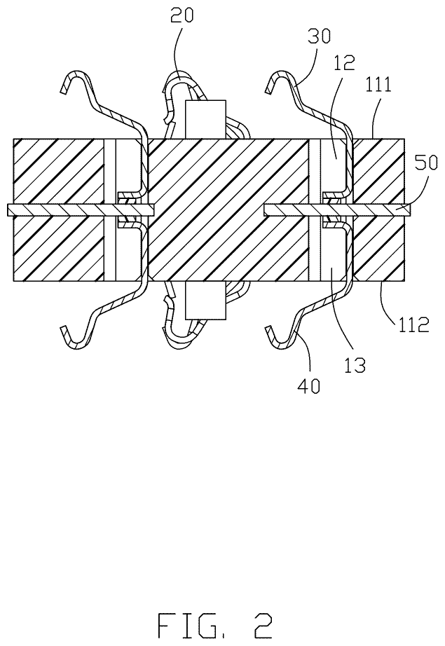

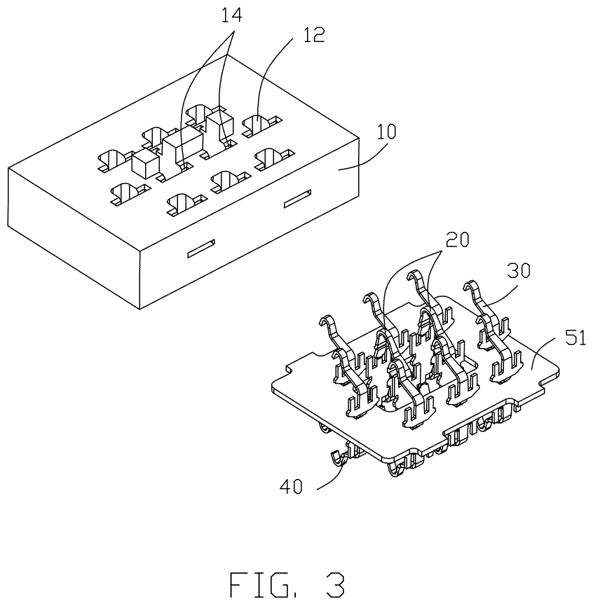

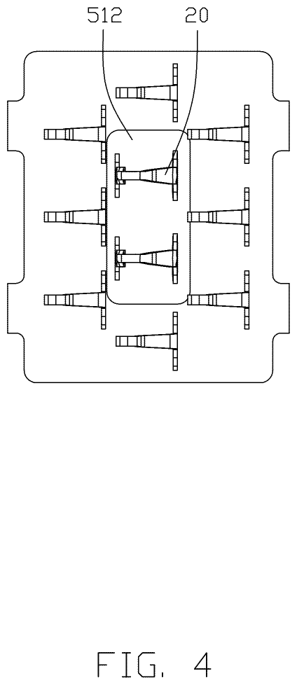

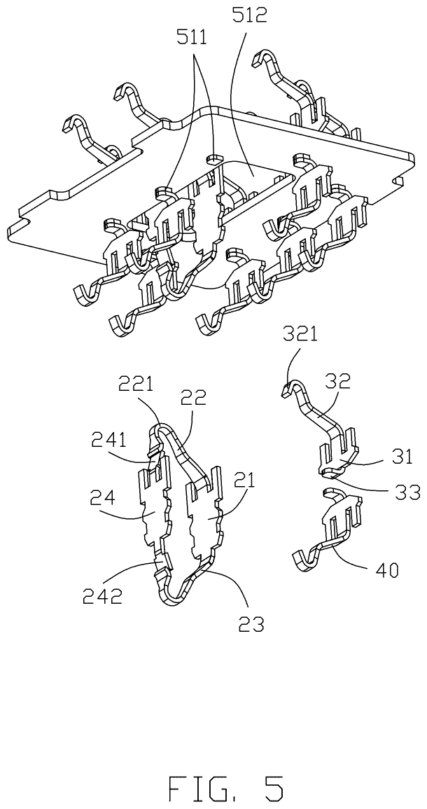

Referring to FIGS. 1-5 illustrating a first embodiment of the present invention, an electrical connector 100 which is only partially figured out in drawings, can be a CPU socket or other IC chip socket connecting between a chip and a circuit board or an interposer connecting between two circuit boards. The electrical connector 100 includes an insulating housing 10 defining an upper face 111 and a lower face 112, a plurality of signal terminals 20 and a plurality of upper ground terminals 30 and a plurality of lower ground terminals 40 retained in the insulating housing 10, and a ground plane 50 in the insulating housing and substantially parallel to the upper and lower surfaces. In drawings, only two signal terminals 20 are shown to define a pair of differential signal terminals. The insulating housing 10 has a plurality of upper passages 12 opening upwards through the upper face 111 and a plurality of lower passages 13 opening downwards through the lower face 112, and a plurality of signal passages 14 running through the upper face and the lower face. The upper ground terminals 30 are received in the upper passage 111 and connected with the grounding plane 50, the lower ground terminals 40 are received in the lower passages 13 and connected with the grounding plane 50. The middle ground plane 50 acts as an additional node in terms of ground resonance, and breaks an original low resonance frequency into two high resonance frequencies, the two high resonance frequency are stacked up but keep a same overall height of the connector, thereby improving the electronic performance of the connector.

In this embodiment, the ground plane 50 is built on a metal plate 51. The metal plate 51 are pro-located with multiple soldering pastes 511 on pre-determined positions thereof and then is insert molded with the insulating housing 10, thereby the metal plate being embedded in the insulating housing 10. The upper passages 12 and the lower passages 13 aligned with each other in an upper and lower direction but partitioned from each other by the metal plate 51, the soldering pastes 511 expose to the upper and lower passages 12, 13. Each of the signal passages 14 goes through in the upper and lower direction via an open 512 defined on the metal plate 51. Each of the upper terminals 30 includes an upright retaining portion 31, an elastic arm 32 extending from the retaining portion with an arc contacting portion 321, and a horizontal soldering portion 33 bending from the retaining portion 31. The upper ground terminals 30 are inserted into the upper passages 12 from the upper face 111 and connected with the metal plate 51 by the horizontal soldering portion 33. In this embodiment, the lower terminals 40 share a same structure with the upper ground terminals 30, both the lower ground terminals 40 are inserted in the lower passages 13 from the lower face 112 and connected with the metal plate 51. The terminals of this connector are of LGA/LGA type. After the upper and lower terminals are inserted into the passages wherein the horizontal soldering portions 33 are seat on the soldering pastes 511, apply SMT process to melt the soldering pastes 511 and cool to fix the grounding terminals with the metal plate by the soldering pastes 511. The horizontal soldering portions 33 of the upper and lower ground terminals are of a SMT leg. The signal terminal 20 are inserted and retained in the through passages 15. Alternatively, the lower ground terminals are different from the upper ground terminals in structure. The elastic arm of the lower ground terminal is replaced with a soldering leg. The terminals of this electrical connector are of LGA/SMT type.

Each of the signal terminal 20 includes a retaining portion 21, two elastic arms 22, 23 extending from opposite ends of the retaining portion 21 each with an arc contacting portion 221, 231, and an additional piece 24 with two supporting portions 241, 242 for touching the contacting portions 221, 231 when the contacting portions 221, 231 are pushed to move towards the insulating housing 10. The retaining portion and the two elastic arms are made to be a main piece, the additional piece 23 is separated from the main piece. In this embodiment, the upper ground terminal is similar to an upper half of the signal terminal, and the lower ground terminal is similar a lower half of the signal terminal. That means, the terminals are punched through a same process.

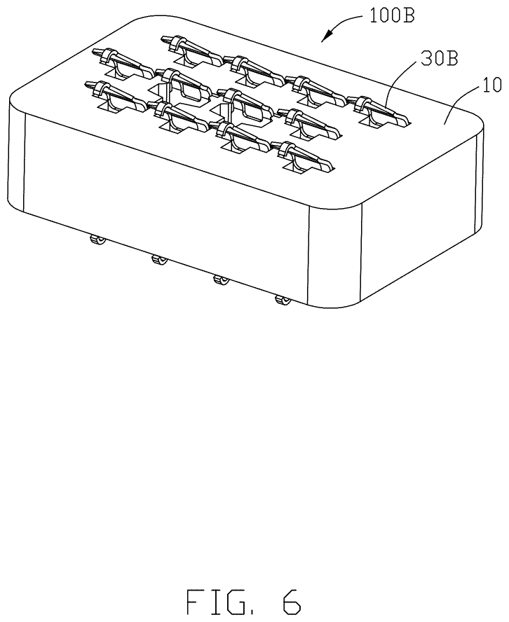

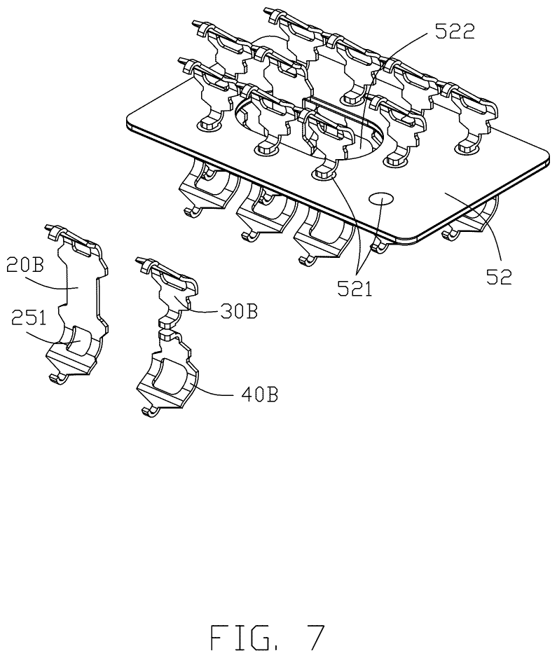

Referring FIGS. 6-7 illustrating a second embodiment of this present invention, an electrical connector 100B is similar to the electrical connector 100. The ground plane is built on PCB 52, i.e., printed circuit board. The PCB 52 has upper ground pads 521 and lower ground pads on opposite faces thereof, the upper ground terminals 30B are connected with the upper ground pads 521 respectively and the lower ground terminals 40B are connected with the lower ground pads respectively. The PCB has openings 521, the signal terminals 20B run through the openings 522 and expose to the upper face and the lower face of the housing. The ground pads 521 are attached with soldering pastes and then soldered with the soldering portions of the lower and upper ground terminals after an SMT process. The PCB 52 is insert-molded with the housing 10 before the insertion of the ground terminals. Alternatively, the PCB 52 can be replaced with an FPC, i.e., flexure printed circuit board. Actually, the PCB or FPC basis ground plane structure can achieve multiple layers of ground planes and easier to increase the overall thickness.

The signal terminal 20B has a different shape from the signal terminal 20 of the first embodiment, which includes an upright retaining portion and two elastic arms extending opposite ends of the retaining portion each with an arc contacting portion. The elastic arm has a slit 251, the elastic arm has a larger width than the elastic arm.

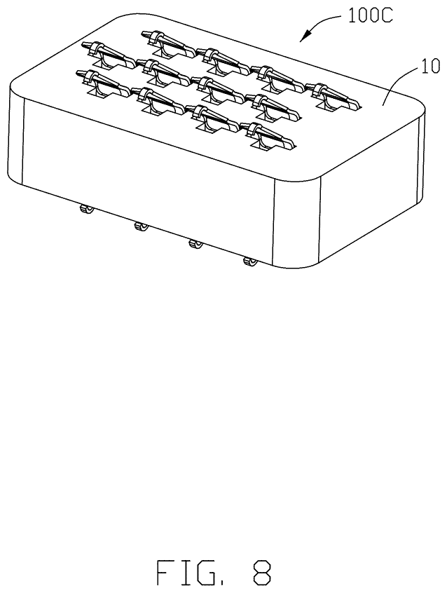

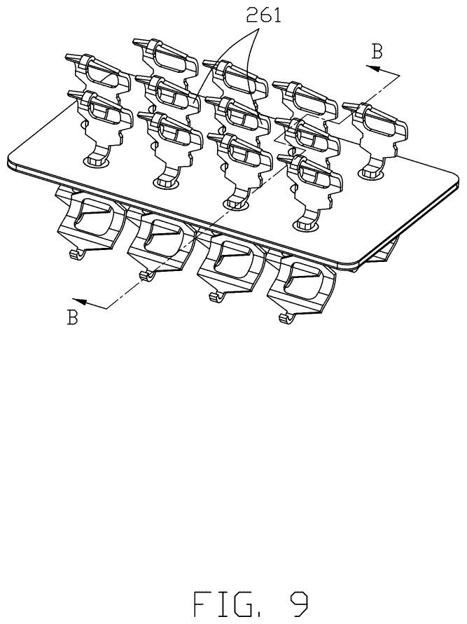

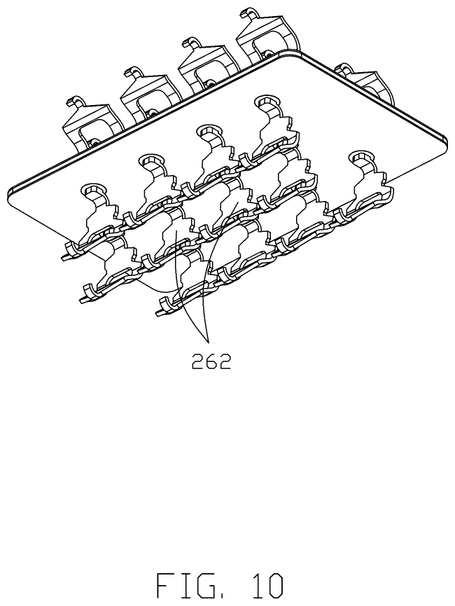

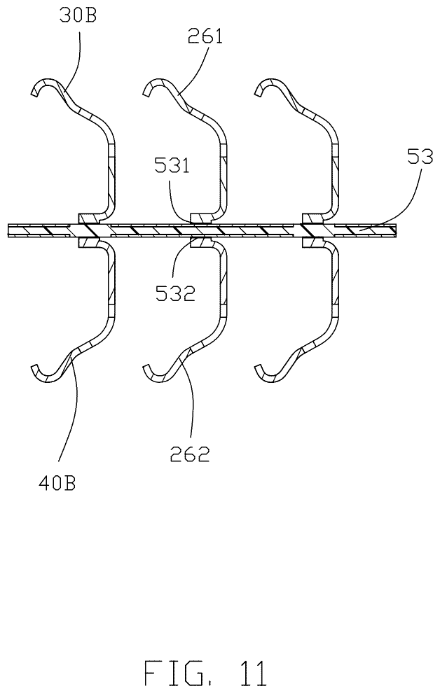

FIGS. 8-11 illustrating a third embodiment of an electrical connector 100C, which is a variant embodiment of the second embodiment. The signal terminals share a same structure of the upper and lower ground terminals. Each of the signal terminals is composed of an upper piece 261 and a lower piece 262. The PCB 53 has upper signal pads 531 and lower signal pads 532 connected with corresponding upper signal pads one by one. The upper pieces 261 of the signal terminals are inserted from the upper face 111 and connected with the upper signal pads 531 respectively, and the lower pieces 262 of the signal terminals are inserted from the lower face and connected with the lower signal pads 532 respectively. That means, the structure of all the terminals are same, and punched at a same process.

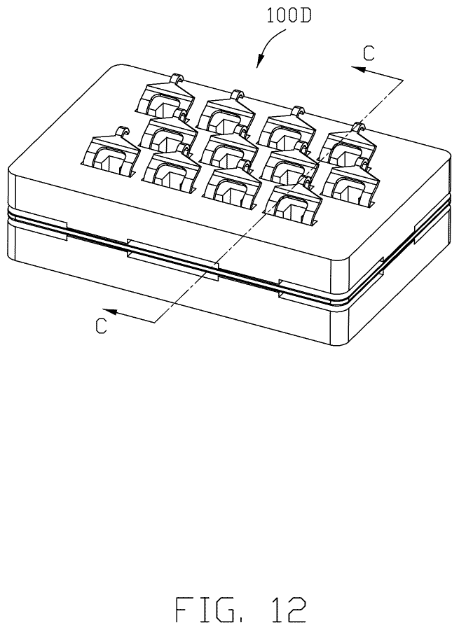

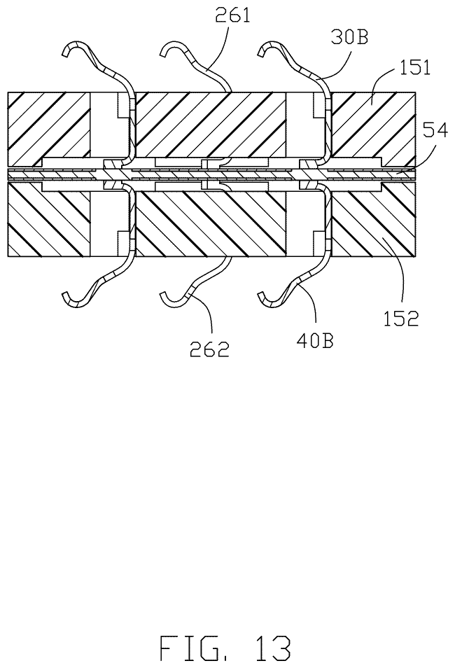

FIGS. 12-13 illustrating a fourth embodiment, the ground plane is built on an FPC or PCB 54. The insulating housing 10 is composed with an upper housing 151 and a lower housing 152, the upper housing is retained with the upper ground terminals 30B and the lower housing 152 are retained with the lower ground terminals 40B firstly, the PCB 54 is then sandwiched between the upper housing 151 and the lower housing 152 when the upper and lower housing are assembled together.

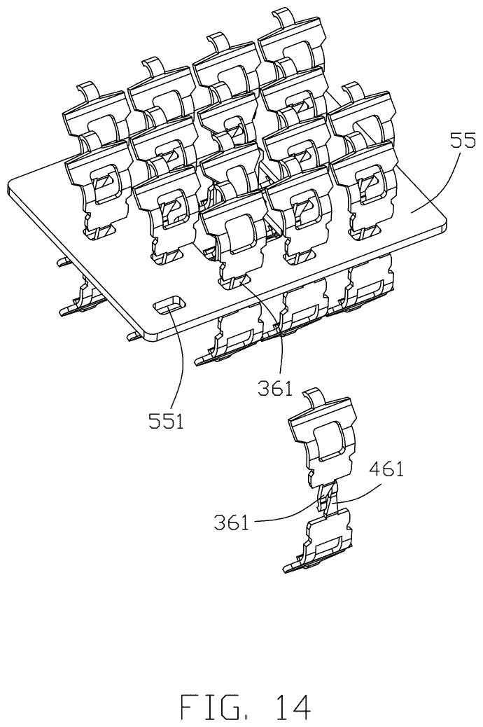

FIG. 14 illustrates a fifth embodiment, wherein the upper and lower ground terminals are mechanically connected with the metal plate 55. The metal plate 55 has a plurality of opens 551, each of the upper or lower ground terminals has a compliant beam 361, 461 with an arc portion, the compliant beams 361, 461 are inserted into the same opening 551, the arc portions touch an inside of the opening to get a mechanical connection with the metal plate 55. The upper and the lower ground terminals share a same structure. The arc portions of the upper and lower ground terminals press against a rear inside of the opening 551 below or above the retaining portion.

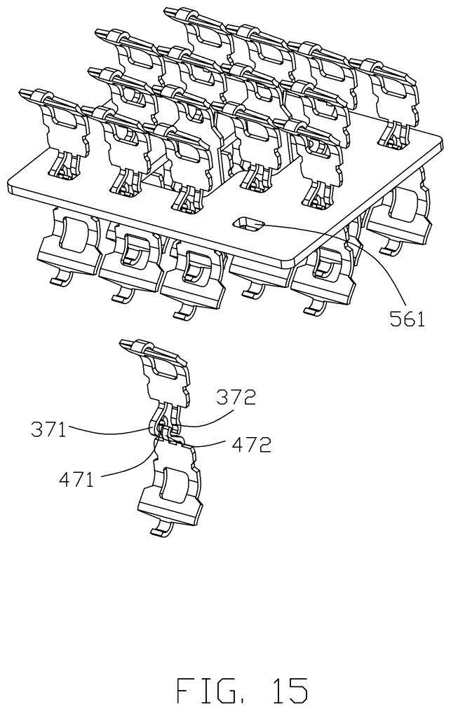

FIG. 15 illustrates a sixth embodiment, wherein each of the upper and lower ground terminals has two compliant beams 371, 372, 471, 472, the compliant beams arc towards opposite directions, the two arc portions touch the opposite insides of the opening 561.

As mentioned before, the combination of the ground plane and the upper and the lower ground terminals meet the need of the terminals to be longer for mechanically but usually shorter for electrically.

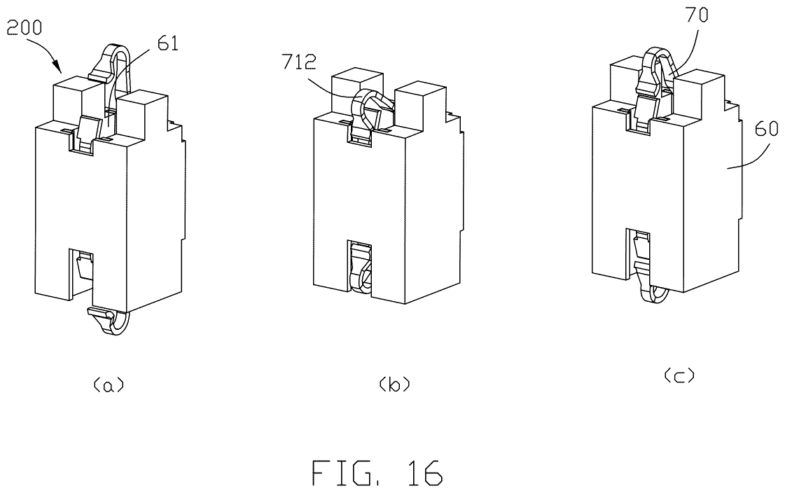

Referring to FIGS. 16-18 illustrating a seventh embodiment of this present invention, an electrical connector 200 includes an insulating housing 60 and a plurality of terminals 70, such as signal terminals, ground terminals or power terminals. In drawings, only one terminal and part of the insulating housing are shown. Each terminal 70 includes a main piece 71 and additional piece 72, the main piece 71 includes an upright retaining portion 711, an upper elastic arms 712 and a lower elastic arm 713, the upper elastic arm 712 has an arc contacting portion 7121 and a distal end 7122 extending from the contacting portion, the lower elastic arm 713 is same to the upper elastic arm. The additional piece 72 includes an upright fixing portion 721, and an upper slanting portion 722 and a lower slanting portion 723 extending from the fixing portion 721.

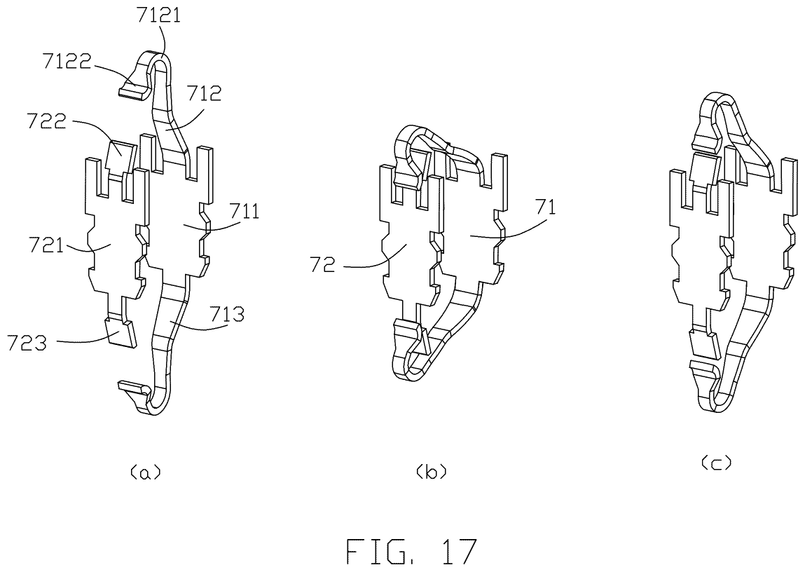

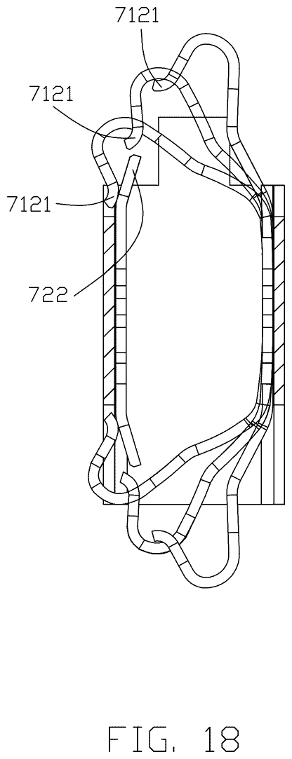

FIG. 16 shows three states of the terminals 70. In FIG. 16(a) and FIG. 17(a), after the two pieces 71, 72 are inserted in the passage 61 running through the upper and lower face of the insulating housing 60, the two pieces are located opposite sides of the passage 61, the upper elastic arm 712 are located above the upper slanting portion 722. As shown in FIG. 18, the distal end 7121 and the upper slanting portion 722 are separated from each other with a gap, thereby avoiding interference of the two pieces during assembly of the terminal.

In FIG. 16(b) and FIG. 17(b), when a first cycle of the upper elastic arms 712 which are actuated inward the insulating housing 60, the upper elastic arms 712 shift downwards and slide along the upper slating portions 722 until getting an internal connection with each other. The terminals activate a secondary electrical path through the additional piece, which generates a parallel circuit and help with lower down the impedance at the elastic arms. Meanwhile a permanent set will happen on the upper elastic arms 712, which mostly close out the gap 73.

In FIG. 16(c) and FIG. 17(c), after recovering from the first cycle, the distal end 7122 of the upper elastic arm 712 is overlapped with the upper slanting portion 722 viewed in a top view. The lower elastic arm 713 is same to the upper elastic arm 712.

However, the disclosure is illustrative only, changes may be made in detail, especially in matter of shape, size, and arrangement of parts within the principles of the invention.

1. An electrical connector comprising:
an insulating housing having an upper face and a lower face;
a ground plane insert-molded in the insulating housing and substantially parallel to the upper face;
a plurality of signal terminals;
a plurality of upper ground terminals; and
a plurality of lower ground terminals;
wherein the insulating housing has a plurality of upper passages opening upwards through the upper face and a plurality of lower passages opening downwards through the lower face, the upper terminals are inserted in the upper passages from the upper face and connected with the ground plane, and the lower ground terminals are inserted in the lower passages from the lower face and connected with the ground plane.

2. The electrical connector as claimed in claim 1, wherein each of the upper terminals and the lower terminals comprises a SMT leg soldered with the ground plane.

3. The electrical connector as claimed in claim 2, wherein a plurality of solder pastes are attached on the ground plane and then connected with the SMT legs respectively.

4. The electrical connector as claimed in claim 1, wherein the ground plane is built on a metal plate.

5. The electrical connector as claimed in claim 4, wherein the metal plate has openings, and the signal terminals run through the openings respectively and expose to the upper face and the lower face of the insulating housing.

6. The electrical connector as claimed in claim 1, wherein the ground plane is built in an FPC or a PCB having upper ground pads and lower ground pads, the upper ground terminals are connected with the upper ground pads respectively, and the lower ground terminals are connected with the lower ground pads respectively.

7. The electrical connector as claimed in claim 6, wherein the FPC or PCB has openings, and the signal terminals run through the openings respectively and expose to the upper face and the lower face of the insulating housing.

8. The electrical connector as claimed in claim 6, wherein the FPC or PCB has upper signal pads and lower signal pads connected with corresponding upper signal pads one by one, each of the signal terminals is composed of an upper piece and an lower piece, the upper pieces of the signal terminals are inserted from the upper face and connected with the upper signal pads respectively, and the lower pieces of the signal terminals are inserted from the lower face and connected with the lower signal pads respectively.

9. The electrical connector as claimed in claim 1, wherein each of the upper ground terminals and the lower grounding terminals comprises a compliant beam connected with the ground plane.

10. The electrical connector as claimed in claim 1, wherein the upper ground terminals and the lower terminals have identical structure and each comprise an upright retaining portion, an elastic arm extending from the retaining portion with an arc contacting portion, and a horizontal soldering portion bending from the retaining portion, and the horizontal soldering portion is soldered with the ground plane.

11. An electrical connector comprising:
an insulating housing having an upper face and a lower face;
a ground plane located in the insulating housing and substantially parallel to the upper face;
two signal terminals defining a pair of differential signal terminals;
a plurality of upper ground terminals; and
a plurality of lower ground terminals;
wherein the upper grounding terminals are connected with the ground plane and the lower terminals are connected with the ground plane.

12. The electrical connector as claimed in claim 11, wherein the upper and the lower ground terminals have identical structure.

13. The electrical connector as claimed in claim 11, wherein the grounding plane has an opening, and the two signal terminals are located across the opening and expose upon the upper face and the lower face of the insulating housing.

14. The electrical connector as claimed in claim 11, wherein a plurality of soldering paste are pre-loaded on the opposite faces of the ground plane and melted with the upper ground terminals and the lower grounding terminals respectively.

15. The electrical connector as claimed in claim 11, wherein the ground plane is built on a metal plate embedded in the insulating housing.

16. The electrical connector as claimed in claim 11, wherein the ground plane is built on an FPC or PCB embedded in the insulating housing.

17. The electrical connector as claimed in claim 11, wherein the ground plane is built on an FPC or PCB, the insulating housing is composed of an upper housing and a lower housing, the upper housing is retained with the upper ground terminals and the lower housing is retained with the lower ground terminals, and the ground plane is sandwiched between the upper housing and the lower housing.

18. The electrical connector as claimed in claim 11, wherein each of the upper ground terminals and the lower grounding terminals comprises a compliant beam connected with the ground plane.
